(19) United States
(12) Patent Application Publication
(10) Pub. No.: US 2013/0235075 A1
(43) Pub. Date: Sep. 12, 2013

(54) NOTIFICATION CONTROL

(71) Applicant: NEC BIGLOBE, LTD., Tokyo (JP)

(72) Inventor: Yoshihiro ONDA, Tokyo (JP)

(73) Assignee: NEC BIGLOBE, LTD., Tokyo (JP)

(21) Appl. No.: 13/713,682

(22) Filed: Dec. 13, 2012

(30) Foreign Application Priority Data
Mar. 6, 2012 (JP) 2012-049243

(51) Int. Cl. G06T 1/00

(52) U.S. Cl. CPC G06T 1/00
USPC 345/619

(57) ABSTRACT

When an incoming call is received by communication section 120, control section 130 changes the state of display on display section 110 to a state of display set in advance, based on the present state of display. When a particular image is being displayed on display section 110, control section 130 changes the state of display on the display section to the state of display set in advance after performing display processing to conceal the particular image.

This application is based upon and claims the benefit of priority from Japanese Patent Application No. 2012-049243 filed on Mar. 6, 2012, the content of which is incorporated by reference.

### BACKGROUND OF THE INVENTION

1. Field of the Invention

The present invention relates to a communication device that controls notification of communication and to a method and program for controlling notification.

2. Description of the Related Art

Most of portable communication terminals in widespread use are capable of making a setting such that when reception of an incoming signal (reception of an incoming telephone call, e-mail or a short message, or the like, referred to as the same meaning below) occurs, vibration is output instead of sound to notify the person having the portable communication terminal of the reception, avoiding causing annoyance to people around the person with the terminal in a public place or the like (hereinafter referred to as “manner mode”).

Also, a technique to notify the sender that a portable communication terminal is in the manner mode state when an incoming signal from the sender is received while the portable communication terminal is in the manner mode has been devised (see, for example, JP2005-223550A).

### SUMMARY OF THE INVENTION

In recent years, portable communication terminals such as smart phones, tablet terminals and mobile computers have come into wide use, and there have been increased opportunities for making an electronic presentation by showing the screen of such a portable communication terminal to viewers.

In a case where an incoming signal is received while the screen is shown to viewers during electronic presentation, however, a display of, for example, “Message from *** has been received” is produced in a pop-up or a notification bar even when the portable communication terminal is in the manner mode and even when the output sound function of the portable communication terminal has been disabled. In such a case, unfortunately, information that should be hidden from view may be displayed or such a display may hinder the progress of an electronic presentation or the like.

An object of the present invention is to provide a communication device, a notification control method and a program capable of solving the above-described problem.

According to the present invention, there is provided a communication device including:

a display section;

a communication section that sends a signal and receives an incoming signal; and

a control section that, when an incoming signal is received by the communication section, changes the state of display on the display section to a state of display set in advance, based on the present state of display,

wherein when a particular image is being displayed on the display section, the control section performs display processing to conceal the particular image and thereafter changes the state of display on the display section to the state of display set in advance.

According to the present invention, there is also provided a notification control method including:

displaying information;

sending a signal and receiving an incoming signal; and

changing to a state of display set in advance, based on the present state of display of the information, when the incoming signal is received,

wherein when a particular image is being displayed, the changing to the state of display set in advance is performed after performing display processing for concealing the particular image.

According to the present invention, there is further provided a program for making a computer execute:

a procedure of displaying information;

a procedure of sending a signal and receiving an incoming signal; and

a changing procedure of changing to a state of display set in advance, based on the present state of display of the information, when the incoming signal is received,

wherein in the changing procedure, when a particular image is being displayed, a procedure of changing to the state of display set in advance after performing display processing for concealing the particular image is executed.

According to the present invention, as described above, only a user of the communication device can recognize that an incoming call has been received.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a diagram showing one exemplary embodiment of a communication device according to the present invention;

FIG. 2 is a diagram showing an example of associations between display states before change and processing to change the display state stored in a storage section shown in FIG. 1;

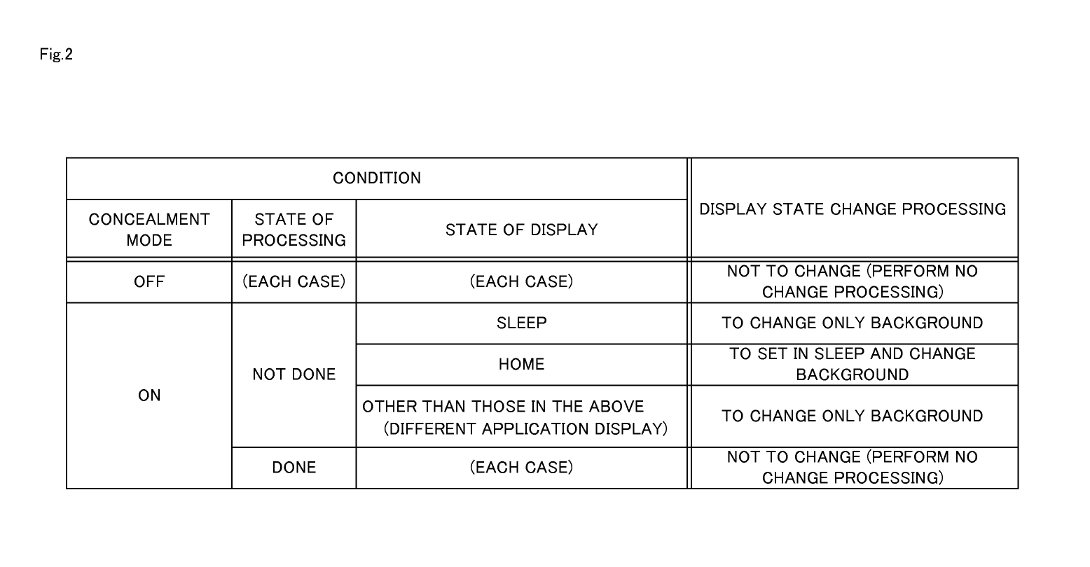

FIG. 3 is an example of a background image to be displayed by a display section before change of the state of display, the background image being stored in the storage section shown in FIG. 1;

FIG. 4 is an example of a background image to be displayed by a display section after change of the state of display, the background image being stored in the storage section shown in FIG. 1;

FIG. 5 is a flowchart for explaining a notification control method in the communication device shown in FIG. 1;

FIG. 6 is a diagram showing an example of the state of display when a background image before change of the state of display, shown in FIG. 3, is displayed on the display section;

FIG. 7 is a diagram showing an example of the state of display when a background image after change of the state of display, shown in FIG. 4, is displayed on the display section;

FIG. 8 is a diagram showing an example of the display section before change of the state of display, on which a widget is displayed;

FIG. 9 is a diagram showing an example of the display section after change of the state of display, on which the widget is displayed; and

FIG. 10 is a diagram showing an example of a display view in a case where the state of display on the display section is a home state.

### DETAILED DESCRIPTION OF THE PREFERRED EMBODIMENTS

An exemplary embodiment of the present invention will be described below with reference to the drawings.

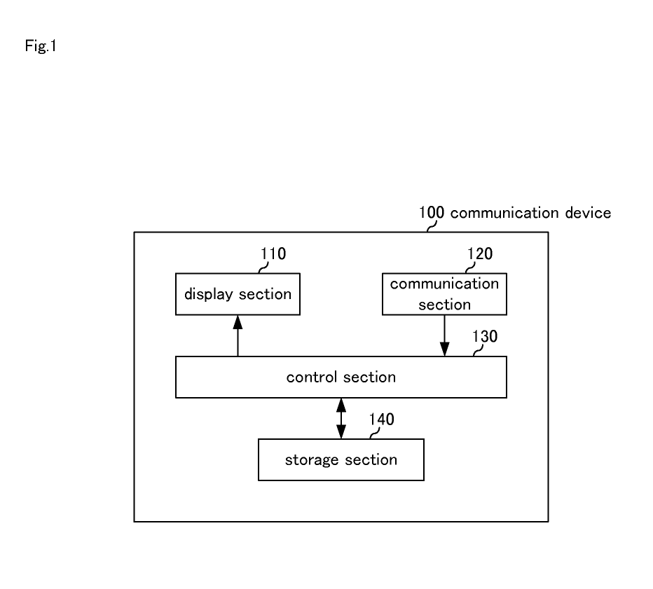

Referring to FIG. 1, communication device 100 includes display section 110, communication section 120, control section 130 and storage section 140. Of components comprising communication device 100, only those relating to the present invention are shown in FIG. 1. Communication device 100 may be a communication device such as a portable telephone or a smart phone, or a tablet, mobile computer or game machine having a communication function.

Display section 110 is a display that displays information based on instructions from control section 130.

Communication section 120 is connected to a network such as a telephone network or the Internet. Communication section 120 performs, based on instructions from control section 130, sending of signals for telephone conversation, a message and electronic mail, and controls signals (initiation of a call, transmission of electronic mail or a short message, or the like, referred to as the same meaning below) and receives incoming signals coming to communication device 100.

Control section 130 performs overall control on communication device 100. Control section 130 may perform control based on an operating system (OS) stored in storage section 140 and an application program. Control section 130 controls display on display section 110 and sending and receiving of signals with communication section 120. When an incoming signal is received by communication section 120, control section 130 changes the state of display on display section 110 to a state of display set in advance. In the case of changing the state of display on display section 110, control section 130 changes the state of display to a state of display according to the state of display before the change. Also, in the case of changing the state of display on display section 110, control section 130 reads processing to change the display state from storage section 140 based on the state of display before changing, i.e., the present state of display, and changes the state of display based on the read change processing. If another incoming signal is received after changing the state of display on display section 110, control section 130 does not further change the state of display on display section 110. However, control section 130 may read from storage section 140 processing to change the display state after the display state is changed on the display section, and may change to a different state of display based on the read processing to change the display state.

The “state of display” on display section 110 refers to a sleep state of display section 110, a state in which a home view is displayed on display section 110 (home state), a state in which a view based on processing by a different application is displayed (different application display), or the like, and to a kind of background image displayed as a background image and a color in which a widget is displayed or a combination of these.

Storage section 140 stores programs such as an OS and applications, a priority table showing priorities assigned to applications associated with various messages and instructions, a file containing information on various settings such as information on setting of a background image (wallpaper) and information on settings of the associated applications, a task table, and files containing temporarily stored messages, book applications, information on records of incoming telephone calls, messages and electronic mail, icons, background images (wallpaper) and various operation setting views, for example. Storage section 140 also stores a state of display on display section 110 before the display state is changed on the display section and processing to change the display state, the state and the processing being associated with each other in advance. Further, storage section 140 stores a background image in a state of display on display section 110 before the display state is changed on the display section and a background image in a state of display after the display state is changed on the display section, the background images being associated with each other in advance.

In storage section 140 shown in FIG. 1, a state of display before the display state is changed on the display section and an operation (processing to change the display state) to be performed when an incoming signal is received are stored while being associated with each other together with conditions for performing the operation. As these conditions, a condition as to whether a concealment mode is on or off (whether a notification control function (display state change function) is set on or off) and a condition as to whether or not processing to change the display state has already been performed are set.

For example, the concealment mode “off”, the state of processing “each case” and the state of display “each case” are associated with processing to change the display state “not to change”. This means that while the concealment mode is off, control section 130 does not perform any processing to change the state of display on display section 110 when an incoming signal is received, regardless of the state of processing and the state of display. Also, the concealment mode “on”, the state of processing “not done” and the state of display “sleep” are associated with processing to change the display state “to change only background”. This means that in a case where the concealment mode is on, and where no processing to change the display state is done, control section 130 changes only the background image (wallpaper) in the display on display section 110 if the state of display on display section 110 is “sleep” (such that the output from display section 110 is off (light-out) or a deep-black view is being displayed on display section 110) when an incoming signal is received. Also, the concealment mode “on”, the state of processing “not done” and the state of display “home state” are associated with processing to change the display state “to set in sleep and change background”. This means that in a case where the concealment mode is on, and where no display state change processing is done, control section 130 changes the state of display on display section 110 to “sleep” and changes the background image if the state of display on display section 110 is “home state” (such that an icon or an widget of an installed application is being displayed on the background image) when an incoming signal is received. Also, the concealment mode “on”, the state of processing “not done” and the state of display “other than those in the above (different application display)” are associated with processing to change the display state “to change only background”. This means that in a case where the concealment mode is on, and where no processing to change the display state is done, control section 130 changes only the image of background (wall paper) on display section 110 if the state of display on display section 110 is other than those in the above, that is, a display is being generated as a full display on display section 110 by a different application when an incoming signal is received. If a display is being generated in a portion of the display on display section 110 by a different application, control section 130 may change the state of display on display section 110 to “sleep” and change the background image. In this different application display, in the state where a view is being displayed by a different application as a full display on display section 110, no background image is displayed on display section 110. Also, the concealment mode “on”, the state of processing “done” and the state of display “each case” are associated with processing to change the display state “not to change (perform no change processing)”. This means that in a case where the concealment mode is on, and where processing to change the display state has already been done, control section 130 does change the state of display on display section 110 (does not perform any processing to change the display state) when an incoming signal is received, regardless of the state of display on display section 110.

In storage section 140, a background image before the display state is changed on the display section and a background image after the display state is changed on the display section, set in advance, are also stored.

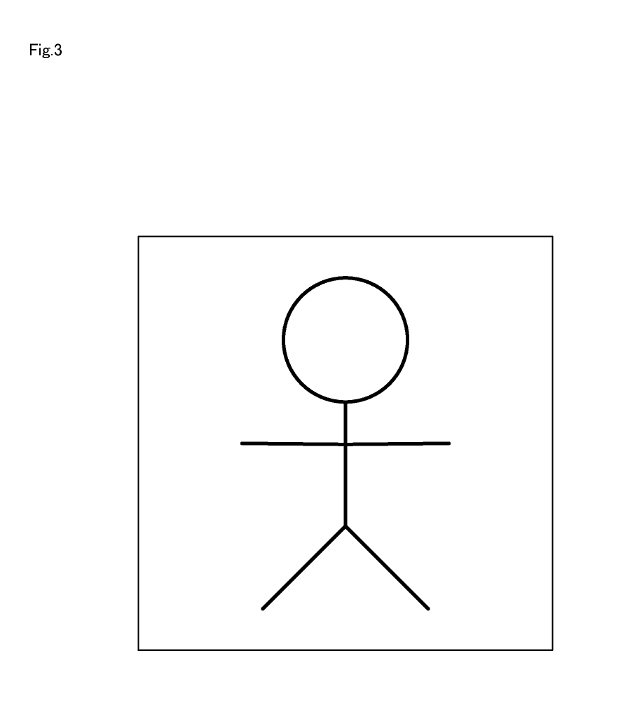

In storage section 140 shown in FIG. 1, a background image to be displayed by display section 110 before the display state is changed on the display section, as shown in FIG. 3, is stored. This background image is selected and input in advance by a user operating communication device 100 on which a setting view is displayed.

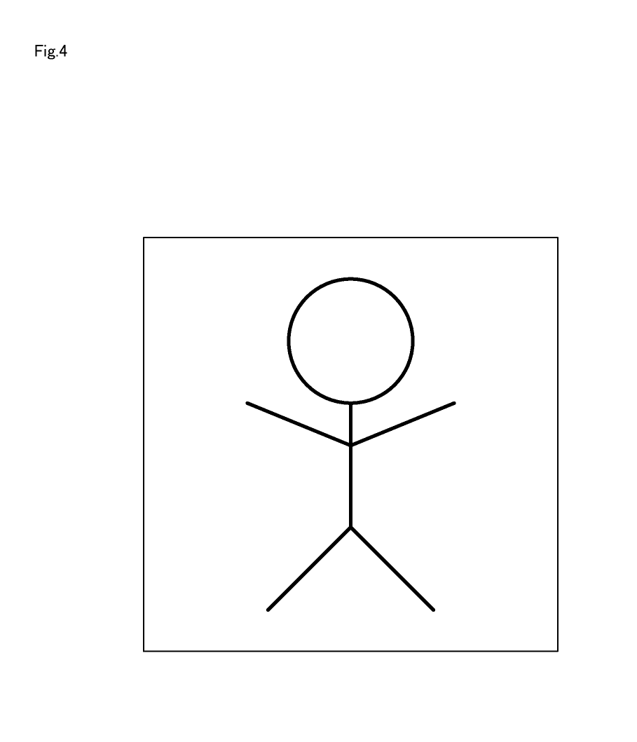

In storage section 140 shown in FIG. 1, a background image to be displayed by display section 110 after the display state is changed on the display section, as shown in FIG. 4, is stored. This background image is stored and set while being associated with the background image before the display state is changed on the display section. Also, this background image is selected, input and set in advance by the user who operates communication device 100. A plurality of background images according to the number of incoming signal receptions may be stored in storage section 140.

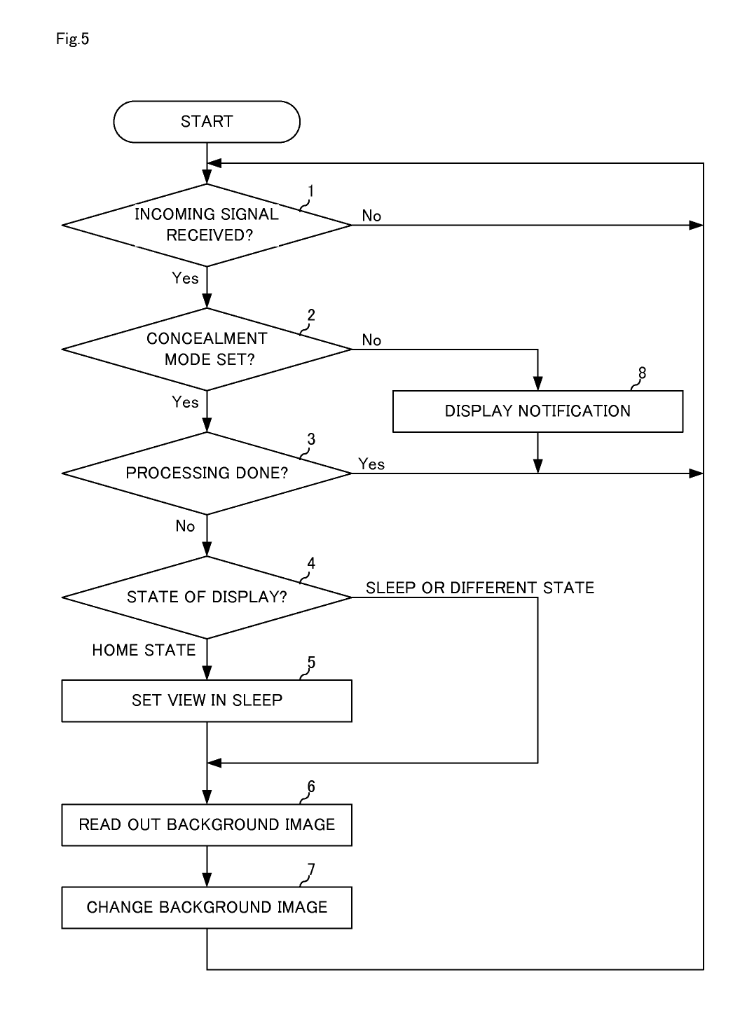

The notification control method in communication device 100 shown in FIG. 1 will be described with reference to FIG. 5. An application on which processing described below is to be performed (a telephone application, a message application such as short message service (SMS), an electronic mail application, or the like) can also be selected. A selecting view for selecting an application on which processing is to be performed may be displayed by display section 110 and an application selected according to an operation performed by the user may be set as a target application.

When an incoming signal is received by communication section 120 in step 1, control section 130 determines in step 2 whether or not the concealment mode has been set to on from the off state (a notification control function application is being executed (on)). If the concealment mode has been set, control section 130 may determine whether or not the incoming signal is for the target application set as an application on which the processing is to be performed.

When the notification control function application is executed (on), control section 130 sets the highest priority for the notification control function application according to the priority table with respect to a processing target incoming signal. When a processing target incoming signal is received, control section 130 executes the notification control function application in at least one of three patterns described below. The first pattern is a pattern in which processing for temporarily storing a message by the notification control function application according to the priority table has been initiated. The second pattern is a pattern in which a non-display setting is made as a notification setting in the application for which the highest priority is set according to the priority table with respect to an incoming signal that must be processed. The third pattern is a pattern in which a notification output from the application for which the highest priority is set according to the priority table with respect to an incoming signal that must be processed is monitored and the notification output is turned off before the notification output is displayed on display section 110. In the case of executing a plurality of patterns, control section 130 executes a predetermined one of the patterns according to the kind of an incoming signal that must be processed.

With respect to each of the patterns, when the notification control function application is changed from on to off, control section 130 sets the highest priority for the application next in priority rank to the notification control function application according to the priority table with respect to an incoming signal that must be processed. Also, control section 130 changes the notification setting of the application for which the highest priority is set by the priority table with respect to an incoming signal that must be processed from non-display to display. Also, control section 130 ends monitoring of the notification output from the application for which the highest priority is set by the priority table with respect to an incoming signal that must be processed.

In the state where the concealment mode is set, control section 130 determines in step 3 whether or not processing to change the state of display on display section 110 has already been performed. Control section 130 may make this determination by reading the incoming signal record stored in storage section 140. Also, control section 130 may make this determination based on the present state of display on display section 110 (whether a background image before change or a background image after change is displayed).

If processing to change the state of display on display section 110 has already been performed, control section 130 will not change the state of display on display section 110 based on the association stored in storage section 140.

On the other hand, if processing to change the state of display on display section 110 has not been performed yet, control section 130 makes a determination in step 4 as to which state is the state of display section 110. Control section 130 may make determination by referring to the task table indicating the task presently being executed, a display layer table indicating the display hierarchy, or the like.

If the state of display on display section 110 is “home”, in step 5, control section 130 sets the view on display section 110 to “sleep” based on the association stored in storage section 140. Subsequently, in step 6, control section 130 reads out a background image after the display state is changed on the display section stored in storage section 140. In step 7, control section 130 replaces the background image displayed on display section 110 with the background image read out from storage section 140. That is, control section 130 may perform processing such that when an incoming signal is received by communication section 120, determination is made as to whether or not a particular image (a background image, a widget, or the like) before the display state is changed on the display section is being displayed in the present state of display on display section 110 and, if the particular image is being displayed, display processing to hide the particular image, for example, by turning off the light is performed and a particular image after the display state is changed on the display section is displayed in place of the particular image before the display state is changed on the display section.

On the other hand, if in step 4 the state of display on display section 110 is sleep (light-out state) or if a display state is different from this, e.g., a state in which a display view produced by a different application is displayed over the entire display on display section 110, control section 130 performs processing in step 6 based on the association stored in storage section 140 without performing processing in step 5.

If the state of display on display section 110 is sleep, or if the state of display has been changed to sleep, processing in step 6 may be performed after a return from sleep. If the state of display on display section 110 is a state in which a display produced by a different application is being displayed, processing in step 6 may be performed before the state of display on display section 110 becomes home after the completion of this application.

In a case where a plurality of background images after the display state is changed on the display section are stored in storage section 140 according to the number of incoming signal receptions, the process may advance to step 4 to change the state of display by reading out the background image according to the number of incoming signal receptions even when processing to change the state of display on display section 110 has already been performed in step 3.

Thus, while no notification of reception of an incoming signal is made and timing of changing background images is not noticed by other persons, the user of communication device 100 can understand from the change of the background images that an incoming signal has been received.

Control section 130 may thereafter write to storage section 140 information indicating that processing to change the display state has been performed. If this operation is performed, control section 130 can read out this information from storage section 140 and use this information to decide when to perform determination processing in step 3. Control section 130 may write this information as an incoming signal record in storage section 140 or may write information indicating that the state of display has been changed.

If the incoming signal not notified is a signal for a message or for electronic mail, control section 130 temporarily stores the message or electronic mail in storage section 140. A storage section in which this message is temporarily stored may be a storage area in storage section 140 managed by the notification control function application or a storage section provided separately from storage section 140.

If the concealment mode is not set in step 2, or if an incoming signal is not to be processed even in the case where the concealment mode is set, control section 130 produces in step 8 a normal notification display, e.g., a display of a pop-up or a notification bar on display section 110.

Output of sound or vibration may be used for notification of reception of an incoming signal as well as a display. In the case where the concealment mode is set in step 2, however, one or all of the outputs other than the display may be prohibited.

Thereafter, when the application which has a function to perform notification control is changed from the on state to the off state (the concealment mode is changed from the on state to the off state, that is, cancelled) by the user who is operating communication device 100, if a received message is temporarily stored in storage section 140, control section 130 refers to the priority table and transfers the temporarily stored message to the application next in priority rank to the application which has a function to perform notification control (an application that handles the corresponding message assigned to it in an ordinary case). Thereafter, instructions to display a notification that the message has been received in a pop-up or in a notification bar is issued by the application that handles the message, as in an ordinary case, and control section 130 displays a corresponding notification on display section 110. The message is stored in a storage area in storage section 140 managed by the application that handles the message.

In a case where a non-display setting made as a setting for an incoming signal notification, as in the case of a telephone incoming call, or where an incoming signal notification is turned off, the notification is not displayed again even after turning off the notification control function. However, since control section 130 leaves the incoming signal as a incoming signal record in storage section 140, the user can call the other party by referring to the incoming signal record (incoming date/time or a telephone number if the caller is in a number-display relationship) after finishing the presentation or the like. In relation to this, the same can also be said with respect to a case where a non-display setting made as a setting for an incoming signal notification of a message or incoming signal notification for a message is turned off.

When the notification control function is changed from the on state to the off state, control section 130 changes the setting to a set background image for ordinary display. Control section 130 reads out the set background image for the ordinary display from storage section 140 according to the background image setting and displays the read image as a background image on display section 110.

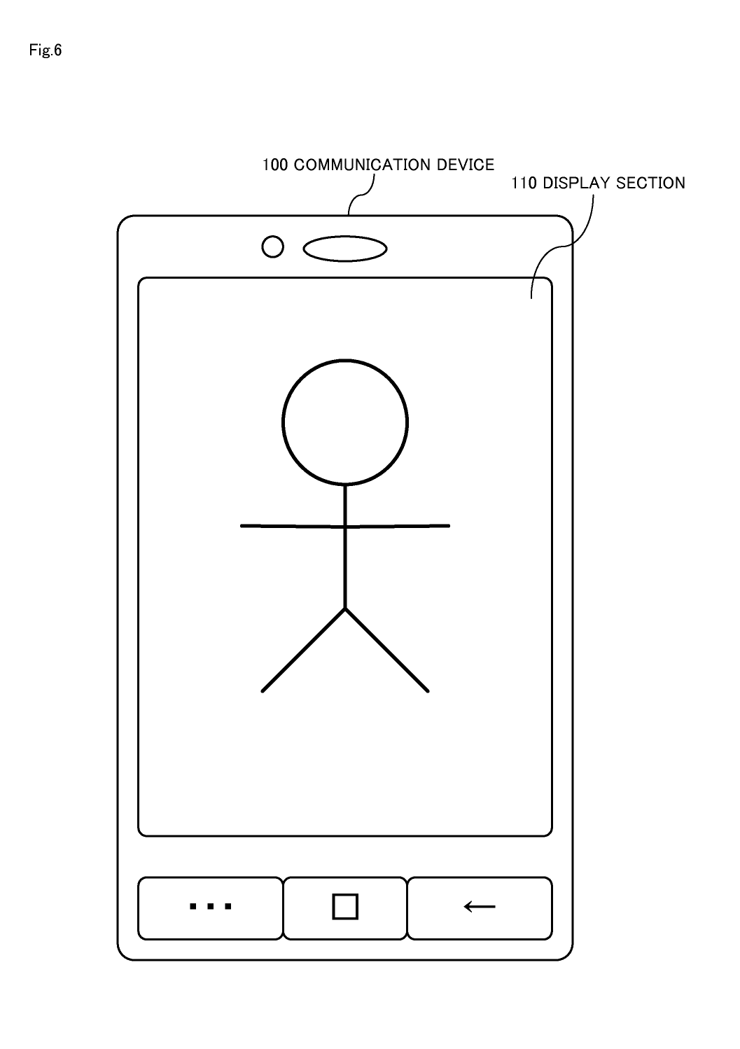

As shown in FIG. 6, a background image before the display state is changed on the display section, stored in storage section 140, is displayed on display section 110 before the display state is changed on the display section.

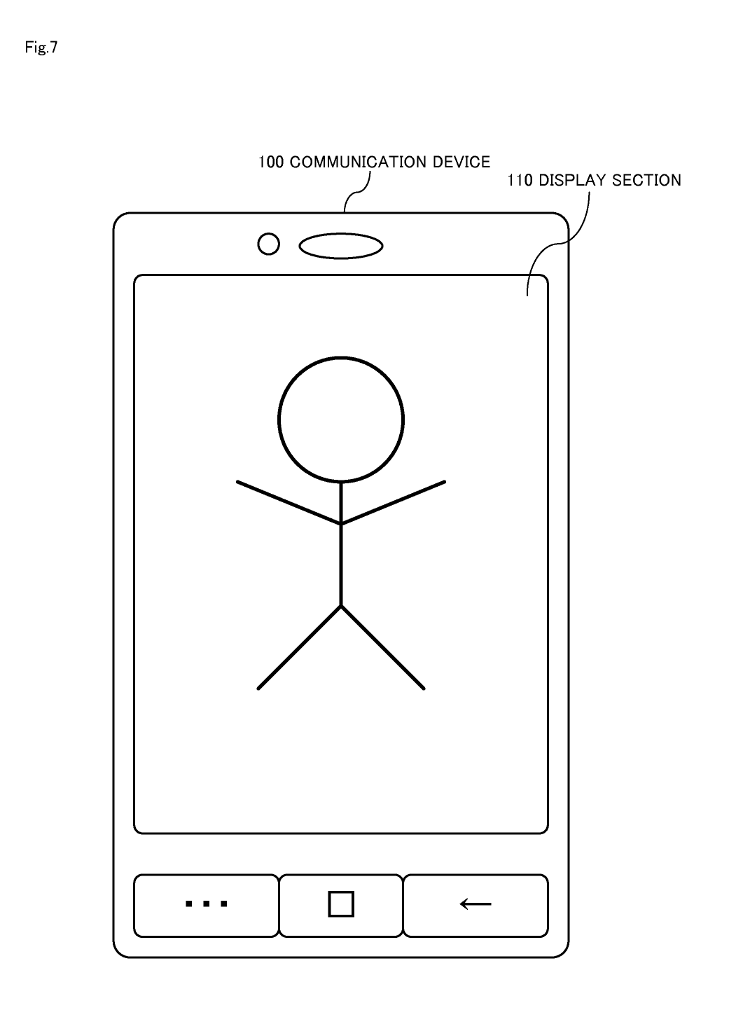

As shown in FIG. 7, a background image after the display state is changed on the display section, stored in storage section 140, is displayed on display section 110 after the display state is changed on the display section.

The color of a predetermined portion displayed on display section 110 may be changed instead of changing the background image.

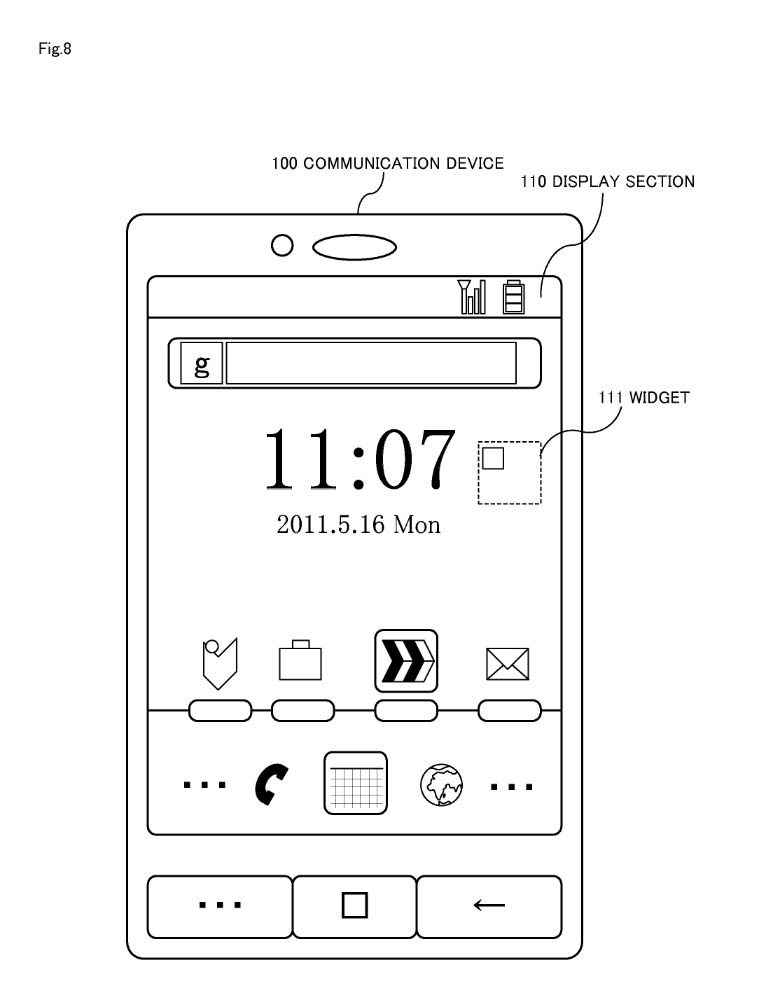

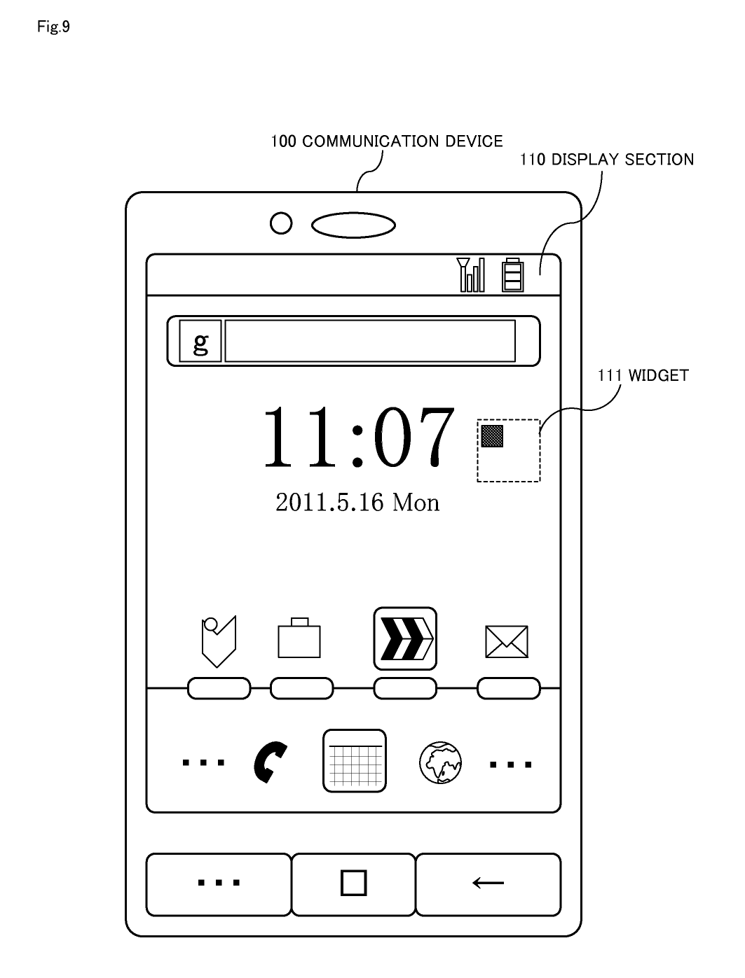

A portion of widget 111 displayed on display section 110 as shown in FIG. 8 is displayed by changing its color after changing the state of display, as shown in FIG. 9.

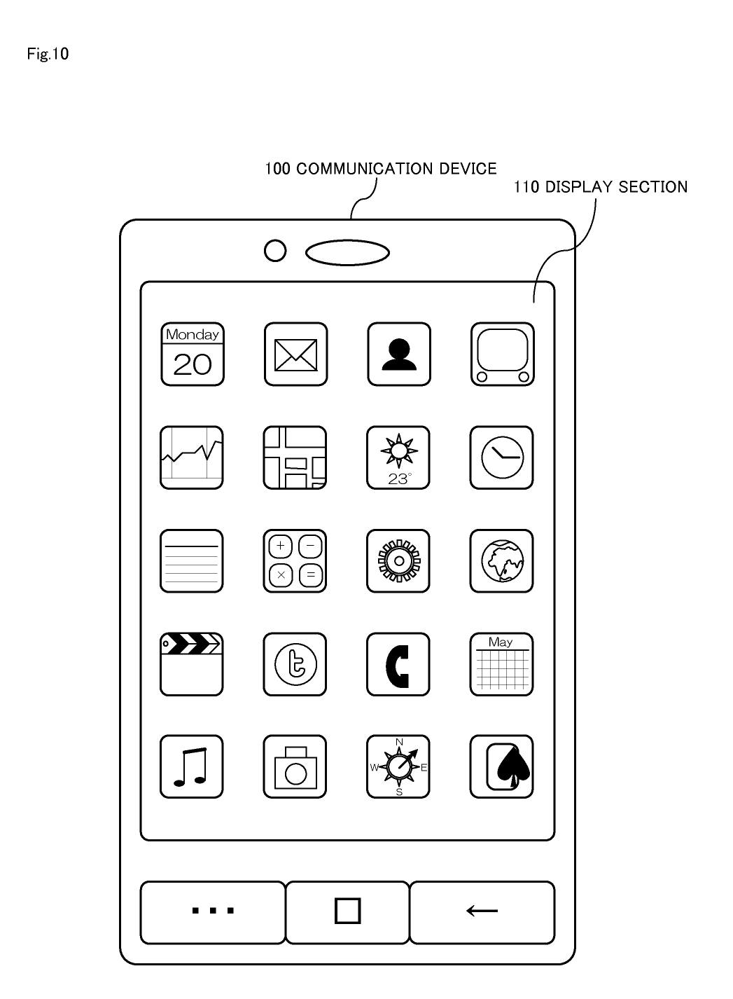

As shown in FIG. 10, in the display on display section 110 in the home state, icons or the like of an installed application are displayed in predetermined positions on the background image. This display may be the same as a general one.

Thus, when an incoming signal is received in the communication device, general information indicating that the incoming signal has been received and information indicating the signal sender are kept in a non-display state and the state of display is changed to a state of display set in advance by the user of the communication device, thereby enabling only the user to recognize the reception of the incoming signal.

Processings performed by the components provided in the above-described communication device 100 may be performed by logical circuits respectively made according to the purpose. A computer program in which details of the processings are written as procedures (hereinafter referred to as “program”) may be recorded on a recording medium readable with communication device 100. The program recorded on this recording medium may be read to communication device 100 to be executed. “Recording medium readable with communication device 100” refers to a removable recording medium such as a floppy (trademark) disk, a magneto-optic disk, a DVD, or a CD, or storage section 140, a memory such as a ROM or RAM, an HDD or the like incorporated in communication device 100. The program recorded on this recording medium is read by control section 130 provided in communication device 100 and the same processings as those described above are performed under the control of control section 130. Control section 130 operates as a computer executing the program read from the recording medium on which the program is recorded.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication device comprising:
a display section;
a communication section that sends a signal and receives an incoming signal; and
a control section that, when an incoming signal is received by said communication section, changes a state of display on said display section to a state of display set in advance, based on the present state of display,
wherein when a particular image is being displayed on said display section, said control section performs display processing to conceal the particular image and thereafter changes the state of display on said display section to the state of display set in advance.

2. The communication device according to claim 1, wherein if an incoming signal is received by said communication section after the state of display on said display section is changed, said control section does not change the state of display on said display section.

3. The communication device according to claim 1, wherein the display processing to conceal the particular image comprises setting said display section in a light out state.

4. The communication device according to claim 1, wherein the particular image is a background image, and wherein, when changing the state of display on said display section, said control section changes the background image displayed on said display section.

5. The communication device according to claim 1, wherein the particular image is a color of a predetermined portion displayed on said display section, and wherein, when changing the state of display on said display section, said control section changes the color of the predetermined portion displayed on said display section.

6. The communication device according to claim 1, wherein said control section changes the state of display on said display section when an incoming call for telephone conversation is received.

7. The communication device according to claim 1, wherein when an incoming signal for a message is received in a state where a concealment mode is set, said control section temporarily stores the message, changes the state of display on said display section to the state of display set in advance, and wherein when the concealment mode is canceled, said control section transfers the temporarily stored message to an application that handles the message.

8. The communication device according to claim 1, further comprising:
a storage section that stores a state of display before the display state is changed on the display section, and processing for changing the state of display in said display section while associating the state of display and the processing with each other,
wherein when an incoming signal is received by said communication section, said control section determines whether or not the particular image is being displayed in the present state of display based on the state of display before the display state is changed on the display section corresponding to the present state of display, and changes the state of display on said display section to the state of display after the display state is changed on the display section based on the processing for changing the state of display associated with the state of display before the display state is changed on the display section in said storage section.

9. The communication device according to claim 1, wherein if the present state of display on said display section is a home state when an incoming call is received by said communication section, said control section determines that the particular image is being displayed on said display section.

10. The communication device according to claim 1, wherein a particular image before change and a particular image after change are set in advance while being associated with each other, and wherein, when changing the state of display on said display section, said control section changes the particular image before the change is displayed on said display section to the associated particular image after the change is displayed on said display section.

11. A notification control method comprising:
displaying information;
sending a signal and receiving an incoming signal; and
changing to a state of display set in advance, based on a present state of display of the information, when the incoming signal is received,
wherein when a particular image is being displayed, said changing to the state of display set in advance is performed after performing display processing to conceal the particular image.
